(19) United States
(12) Patent Application Publication
(10) Pub. No.: US 2012/0313604 A1
(43) Pub. Date: Dec. 13, 2012

(54) EFFICIENT BIAS POWER SUPPLY FOR NON-ISOLATED DC/DC POWER CONVERSION APPLICATIONS

(76) Inventor: Muzahid Bin Huda, Los Gatos, CA (US)

(21) Appl. No.: 13/492,501

(22) Filed: Jun. 8, 2012

Related U.S. Application Data
(60) Provisional application No. 61/520,453, filed on Jun. 10, 2011.

(51) Int. Cl. G05F 1/618

(52) U.S. Cl. 323/282

(57) ABSTRACT

Unique methods are disclosed to construct an efficient bias supply for a main non-isolated DC/DC power conversion system. Additional bias supplies developed by employing an arbitrary number of transformers and/or an arbitrary number of secondary windings can be used to provide bias power to other isolated and non-isolated power conversion systems. By employing a transformer in forward conversion mode the basic circuit of the efficient bias supply is built without using any extra switching controllers and power switches. Furthermore a new architecture for monitoring and selecting the bias power source to ensure smooth start-up and operation during abnormal conditions and/or maintaining optimum and efficient steady state operation of a power conversion system is disclosed.

### CROSS REFERENCE TO RELATED APPLICATION

This application claims priority from and incorporates by reference the following US Provisional Application: “Efficient bias power supply for non-isolated DC/DC power conversion applications”, Ser. No. 61/520,453 filed on Jun. 10, 2011.

### BACKGROUND OF THE INVENTION

1. Field of the Invention

The field of the present invention pertains to electrical power conversion. The present invention relates to an efficient bias supply development for non-isolated DC/DC power conversion applications.

2. Description of Related Art

In a typical DC/DC converter such as synchronous buck, synchronous/non-synchronous boost, and other topologies the bias supplies to operate the controller and driver circuit are derived using one or more linear regulators. This causes significant loss in power efficiency. To address this problem, prior art is demonstrated by the following patents:)
a) U.S. Pat. No. 7,202,643 B2 issued to Rais K. Miftakhutdinov, “High Efficiency DC-To-DC Synchronous Buck Converter”, Dated Apr. 10, 2007
b) US Patent no. US 2006/0196757 A1 issued to Hang-Seok Choi, “Switching Mode Power Supply and Method for Generating Bias Voltage”, Dated Sep. 7, 2006.

### SUMMARY OF THE INVENTION

This disclosure describes a unique circuit applicable to all non-isolated topologies such as, but not limited to, buck, boost, SEPIC and other converter circuits that have an active switch connected to the ground (negative power input) terminal. The application of such topologies incorporating this invention include but are not limited to, Point of Load (POL) converters, battery chargers, LED drivers, solar power conversion and other power conversion systems. The embodiments described in this disclosure achieve higher overall power efficiencies in such types of converters. For the purposes of this invention disclosure, the terms switching controller, PWM controller, variable frequency controller, constant on-time controller and constant-off time controller may all be used interchangeably and all are equally applicable. The novelties of this invention are as follows:
a) Generation of one or more bias voltages without using an additional control logic and power switching stage.
b) Use of one or more transformers and/or one or more windings to generate one or more bias supplies.
c) The bias supplies developed by adding an arbitrary number of transformers having an arbitrary number of secondary windings, then each of the secondary windings can provide isolated bias power to a corresponding number arbitrary other isolated or non-isolated power converters. Examples of applications include but are not limited to bias supplies for half bridge, full bridge DC/DC, DC/AC, AC/AC and AC/DC power conversion systems.
d) A supervisory circuit that monitors the input supply and the generated bias supply to decide and select the most efficient power source under stable and/or abnormal conditions.

### BRIEF DESCRIPTION OF THE DRAWINGS

FIG. 1 shows a simplified schematic of the power stage of a synchronous Buck regulator. Only the main components directly relevant to the present invention are depicted.

FIG. 2 shows the simplified block diagram of a typical synchronous MOSFET driver (Gate driver).

FIG. 3 shows one embodiment of this invention. It shows a simplified diagram of the power stage of a synchronous buck converter and components of the present invention.

FIG. 4A and FIG. 4B show two versions of a second embodiment of this invention. FIG. 4A shows a simplified diagram of the power stage of a boost converter with synchronous rectifier. FIG. 4B shows the simplified diagram of the power stage of a boost converter with a non-synchronous boost diode.

FIG. 5 shows a third embodiment of this invention. It shows a simplified diagram of the power stage of a synchronous boost regulator and the components of the present invention.

FIG. 6 shows the Simplified schematic of a linear regulator commonly used to provide power to the switching controller, or the gate driver, or a combination of the two.

FIG. 7A and FIG. 7B show two embodiments of a new, efficient architecture to replace the common linear regulator of FIG. 6.

FIG. 8 shows another embodiment of the present invention. It shows a simplified diagram of the power stage of a SEPIC regulator and the components of the present invention. The embodiment of this invention with a Cuk converter is analogous to that with the SEPIC regulator and is not shown for brevity.

FIG. 9 shows one embodiment of the complete bias supply circuit for the PWM or switching controller and gate driver.

### DETAILED DESCRIPTION

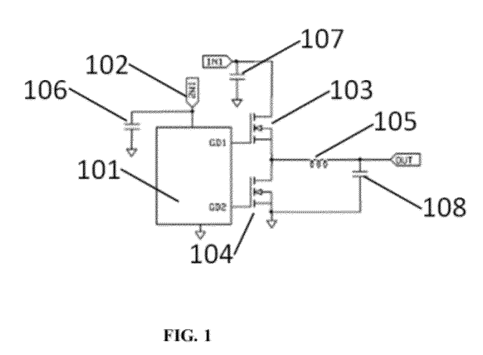

FIG. 1 shows a simplified schematic of the power stage of a synchronous Buck regulator. For clarity, only the main components that are relevant to the present invention are depicted. Additional components such as the PWM or switching controller, and circuitry such as the feedback loop necessary to implement a complete buck regulator are not shown. 101 represents a conventional switching controller and synchronous MOSFET driver with outputs GD1 and GD2. Alternately, 101 represents only a standalone switching controller or the synchronous gate driver. 102 (IN2) shows the supply input to 101. 102 can be an independent supply input or it may be tied to the terminal labeled “IN1”. 103 and 104 are the power switching MOSFET and the synchronous MOSFET respectively. The current flowing into the load flows through filter inductor (105). 106, 107 and 108 are filter capacitors.

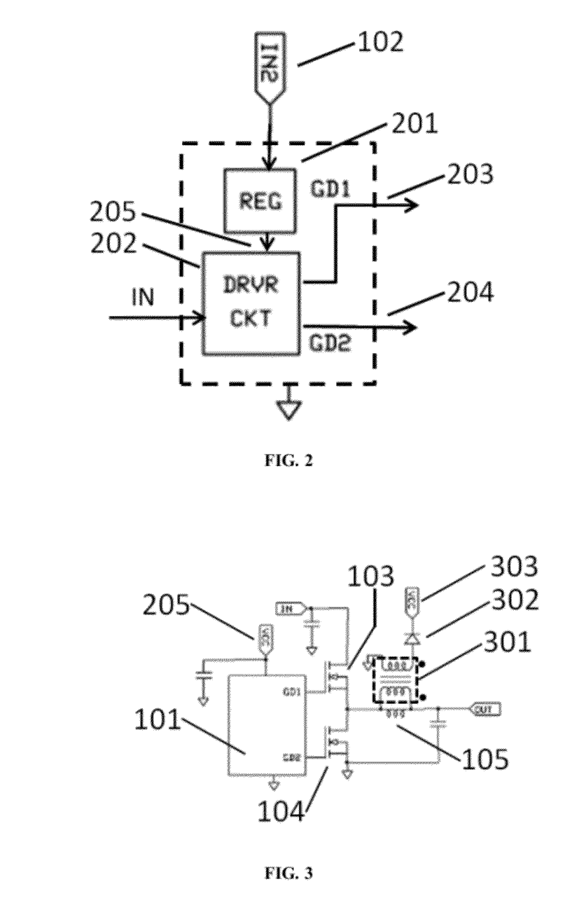

FIG. 2 shows the simplified block diagram of a conventional synchronous MOSFET driver (Gate driver) implemented in an integrated circuit (IC). 102 is the supply input to the linear regulator of the MOSFET driver, and corresponds to 102 of FIG. 1. 201 is the voltage regulator block of the MOSFET driver. In most implementations, it supplies all the current in the logic and analog circuits of the MOSFET driver as well as the output gate drive current. 202 shows the driver block that includes logic, level shift and driver circuitry. 203 and 204 are the driver outputs, marked as GD1 and GD2 respectively. 203 and 204 provide high current drive to rapidly switch the external power switching and synchronous MOSFETs.

205 indicates the output of the voltage regulator (201). In most cases, 201 is implemented as a linear regulator, but it is also implemented as a switching regulator in some applications. The linear regulator (201) dissipates power equal to the product of the voltage difference between its input (102) and output (205), multiplied by the current supplied to the MOSFET driver's internal circuitry including the output drivers. Since this current can be substantial, the power dissipation in the linear regulator (201) can be high. The power distribution described also applies to non-synchronous gate or MOSFET drivers.

FIG. 3 shows one embodiment of the present invention. It shows a simplified diagram of the power stage of a synchronous buck converter along with the components used in this invention. 101, 103, 104 and 105 correspond to those of FIG. 1. 301 through 303 depict the components used in this embodiment of the present invention. 301 is the transformer whose primary winding is connected across 105. 302 is a rectifier used to rectify the switching voltage across the secondary winding of 301. 303 is the output of the rectifier that is connected to the node labeled 205. Filter capacitors attached between 303 and the ground terminal are not shown for simplicity. Any arbitrary number of secondary windings can be implemented in the transformer (301), which combined with rectifiers analogous to 302 and filter capacitors not shown for simplicity, can generate multiple dc voltages.

Circuit Operation:
When the synchronous MOSFET (104) switches on, the voltage across filter inductor (105) equals the regulated output voltage of the buck converter. Since the primary winding of transformer (301) is connected across 105, the voltage across the primary winding is also equal to the regulated output voltage of the buck converter.
The primary voltage multiplied by the transformer's secondary to primary turns ratio appears across the secondary winding. This voltage is rectified by 302 and its output (303), which is a DC voltage, is applied to 205. The voltage at the rectifier's output (303) is regulated and maintained at a fixed value because the output voltage of the synchronous buck converter is regulated. Therefore a separate, dedicated feedback loop to maintain regulation at the 205 is not necessary.

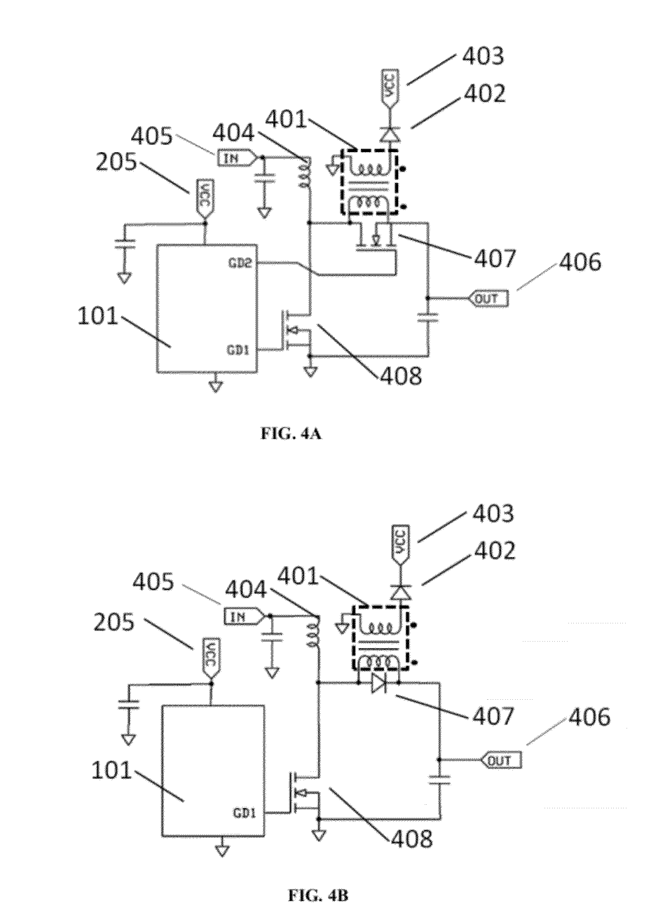

FIG. 4A and FIG. 4B show two versions of a second embodiment of the invention. FIG. 4A shows a simplified diagram of the power stage of a boost converter using a synchronous rectifier, along with the components of this invention. FIG. 4B shows the same simplified diagram of the power stage of the boost converter using a non-synchronous boost diode. FIG. 4B also shows the components of this invention. 101 represents the switching controller or gate driver, or a combination of the two. Transformer (401), rectifier (402) and rectifier output (403) are components of the present invention used with either implementation of the boost converter circuit. 401 through 403 correspond to 301 through 303 respectively as in FIG. 3. Filter capacitors attached between 403 and the ground terminal are not shown for simplicity. 404 is the boost inductor. 407 and 408 are the active power switches. For the synchronous boost converter, the primary winding of 401 is connected across synchronous rectifier (407). Similarly, for the boost converter with non-synchronous boost rectifier, the primary winding of 401 is also connected across 407, which in this case is a rectifier diode.

The switching voltage across the secondary winding of 401 is rectified by 402. 403, which is the output of the rectifier (402) supplies power to the supply input to 205. Any arbitrary number of secondary windings can be implemented in the transformer (401), which combined with rectifiers analogous to 402 and filter capacitors not shown for simplicity, can generate multiple dc voltages.

Circuit Operation:

Operation with the Boost Converter (FIG. 4a and FIG. 4b):
i. FIG. 4A; Operation with synchronous boost converter: 405 and 406 denote the input and output power nodes respectively of the synchronous boost converter. When the switching MOSFET (408) switches on, the voltage across the synchronous rectifier (407) equals the boost regulator's output voltage (Voltage at 406).
   Since the primary of the transformer (401) is connected across 407, the voltage across the primary winding also equals the boost output voltage. Then the voltage across the secondary winding of 401 equals the boost regulator's output voltage, multiplied by the secondary to primary turns ratio. This voltage is regulated if the boost regulator's output voltage is regulated.
ii. FIG. 4B; Operation with boost converter with non-synchronous boost rectifier diode: 405 and 406 denote the input and output power nodes respectively of the non-synchronous boost converter. When the switching MOSFET (408) switches on, the voltage across the non-synchronous boost rectifier (407) equals the boost regulator's output voltage (Voltage at 406). Since the primary of the transformer (401) is connected across 407, the voltage across the primary winding also equals the boost output voltage. Then the voltage across the secondary winding of 401 equals the boost regulator's output voltage, multiplied by the secondary to primary turns ratio. This voltage is regulated if the boost regulator's output voltage is regulated.
In both the synchronous boost regulator and the boost converter with non-synchronous rectifier diode, this voltage developed across the secondary winding of 401 is rectified by 402 and its output (403), which is a DC voltage, is applied to 205.
The voltage at the rectifier's output (403) is regulated and maintained at a fixed value if the boost regulator's output voltage is maintained in constant regulation. Therefore a benefit of this invention is that a separate, dedicated feedback loop to maintain regulation at 205 is not necessary.

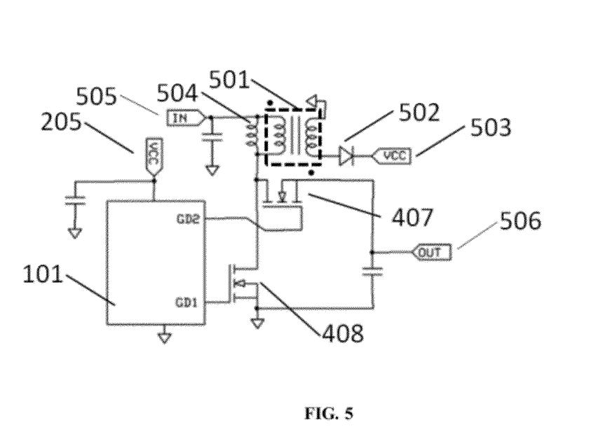

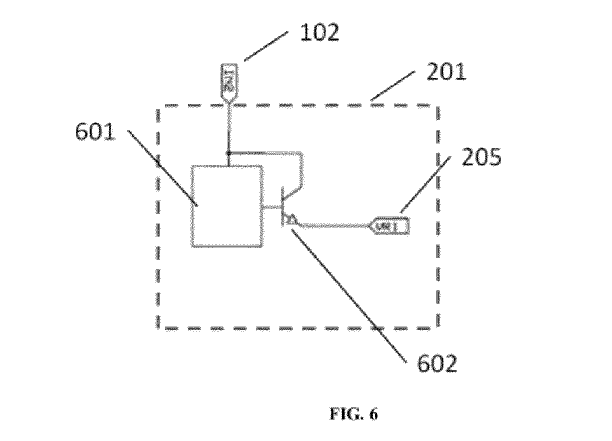

FIG. 5 shows a third embodiment of this invention. It shows a simplified diagram of the power stage of a synchronous boost regulator and the components of the present invention. 101 represents the switching controller or gate driver, or a combination of the two. In FIG. 5, transformer (501) corresponds to 401, and boost inductor (504) corresponds to 404 of FIG. 4A and FIG. 4B. The difference in this embodiment from those of FIG. 4A and FIG. 4B is that the primary of 501 is now connected across the boost inductor (504). This embodiment applies to both synchronous and non-synchronous boost regulators.

Since the primary winding of 501 is connected across the boost inductor (504), the rectified output voltage at 503 approximately equals the input voltage multiplied by the secondary to primary turns ratio of the transformer (501). The voltage at the rectifier's output (503) is regulated and maintained at a fixed value as long as the input voltage (505) is constant. This is the supply voltage provided to 205.

Any arbitrary number of secondary windings can be implemented in the transformer (501), which combined with rectifiers analogous to 502 and filter capacitors not shown for simplicity, can be used to generate multiple dc voltages. When the input voltage to the boost converter is constant, a separate, dedicated feedback loop to maintain regulation at 205 is not necessary.

FIG. 6 shows the typical linear regulator that conventionally regulates the input voltage (Usually between 10V and 20V) to the switching controller, or gate driver, or a combination of the two to a lower voltage (Usually 5V). In certain instances this gate driver block may also be integrated on the same die with the switching controller circuit. In other instances, the gate driver may be implemented with discrete components in conjunction with either a discrete or integrated PWM or switching controller circuit. This is the block described as 201 in FIG. 2. Significant amounts of current are delivered by this regulator to the gate driver's outputs during the turn on and turn off transitions of the power switch and synchronous rectifier. This causes a significant amount of power loss in the pass transistor (602), reducing the overall efficiency of the power conversion system.

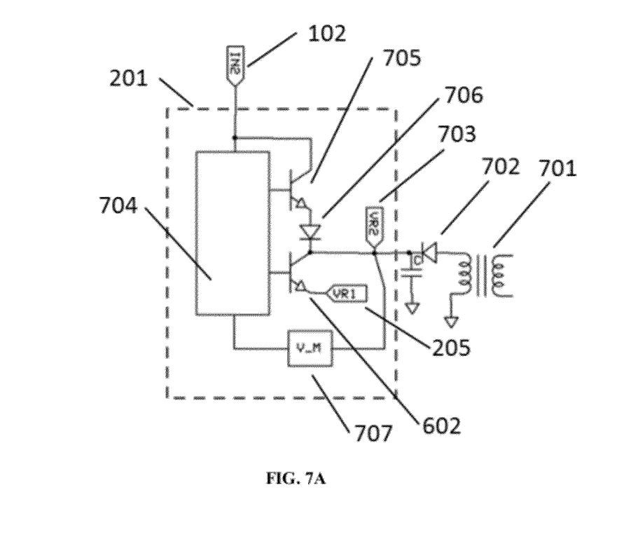

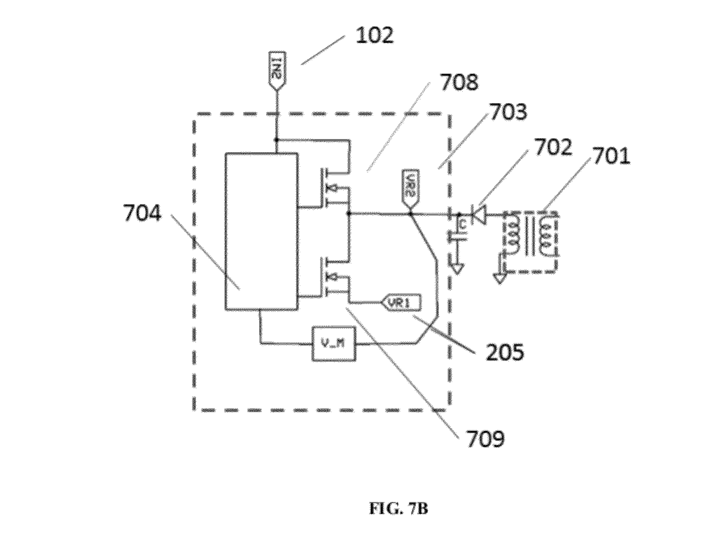

FIG. 7A shows the details of the present invention in which the linear voltage regulator block 201 of FIG. 6 has been improved to increase efficiency. 102 and 205 are the supply input and output respectively of this regulator, and are analogous in function to those of FIG. 6. 602 is the BJT that was also described in FIG. 6. In FIG. 7A however, the control block (601) of FIG. 6 has been replaced by a new supervisory block (704). A second BJT pass transistor (705) that works in conjunction with 602 has also been added. 703 functions as a bidirectional node to provide power to the gate driver circuitry. At start-up, power flows from 102 and via 705 and 706. Once stable switching operation is achieved, 701 and 702 more efficiently provide the power (at the node labeled VR2, or 703) required by the gate driver circuitry. 706 is a blocking diode. 707 is the monitoring or feedback path used to read the voltage at the node labeled 703.

FIG. 7B shows a variation of the invention described in FIG. 7A. In this variation, the BJT pass transistors (705 and 602) have been replaced with MOSFETs (708 and 709 respectively).

In a third variation of this embodiment, 708 is a MOSFET and 709 is a BJT. In yet a fourth variation, 708 is a BJT and 709 is a MOSFET. Identical to FIG. 7A, in FIG. 7B the cathode of 702 (Diode) is also connected to 703. The primary of the transformer (701) is connected to the power stage of a synchronous buck regulator according to FIG. 3, or to the power stage of a synchronous or non-synchronous boost regulator according to FIG. 4A, FIG. 4B or FIG. 5. In general, to obtain a regulated output voltage at the cathode of 702, the primary side of 701 can be connected between the switching node of an active power switch to ground or the common terminal, and the regulated output.

Circuit Operation:

Circuit operation is described with reference to FIG. 7A. The operation of FIG. 7B is identical to that of FIG. 7A, with the exception of the blocking diode (706), which is not necessary in most cases since the maximum reverse Gate to Source voltage rating of typical MOSFETs used is much higher than the maximum reverse base to emitter voltage rating of a BJT. However, an optional diode may be used in series with the source of 709 to increase the maximum reverse voltage that can be sustained without damaging 709. The difference between the voltages at 102 and 703 is dropped across 705 and 706. Then the voltage difference between 703 and 205 is dropped between the collector and emitter terminals of 602.

At start-up, 102 is the primary supply to the supervisory circuit (704), driver (703) and switching controller via the node VR1 (205). For simplicity, the gate driver circuit is not shown in FIG. 7A and FIG. 7B. Referring to FIG. 7A, an external voltage is applied to the input (102). The supervisory block (704), along with the two pass transistors (705 and 602) regulate the output voltages VR2 and VR1 (703 and 205) to the desired, lower arbitrary values. Regulation for VR2 is accomplished by monitoring the voltage at 703 via the feedback block (707), and feeding this monitored voltage directly or some arbitrary representation of this monitored voltage in either analog or digital form to the supervisory block (704). 704 compares this feedback information against a reference voltage or against an arbitrary analog or digital representation of the reference voltage to switch off 705 (FIG. 7A). For simplicity, the reference voltage or its arbitrary digital or analog representation is not shown in FIG. 7A and FIG. 7B. When the bias supply is available via 701 and 702, 705 (FIG. 7A) is switched off, and the nodes at 205 and 703 are both completely supplied by the transformer (701) and rectifier diode (702) combination. A capacitor is normally connected between 703 and the ground to smooth the voltage at 703 into a DC voltage.

In a power conversion application, 703 is connected such that it supplies the gate driver's power output stage. It supplies the current required by the gate driver to switch the switching transistors of the power converter on and off. Since the circuits of FIG. 7A and FIG. 7B are more efficient than the typical circuit of FIG. 6, they help to improve the efficiency of the overall power conversion system.

Under abnormal conditions, the supervisory circuit optionally decides to switch the power flow source back to the input pin (102) for the entire circuit which includes the gate driver circuit and/or the PWM or switching controller circuit.

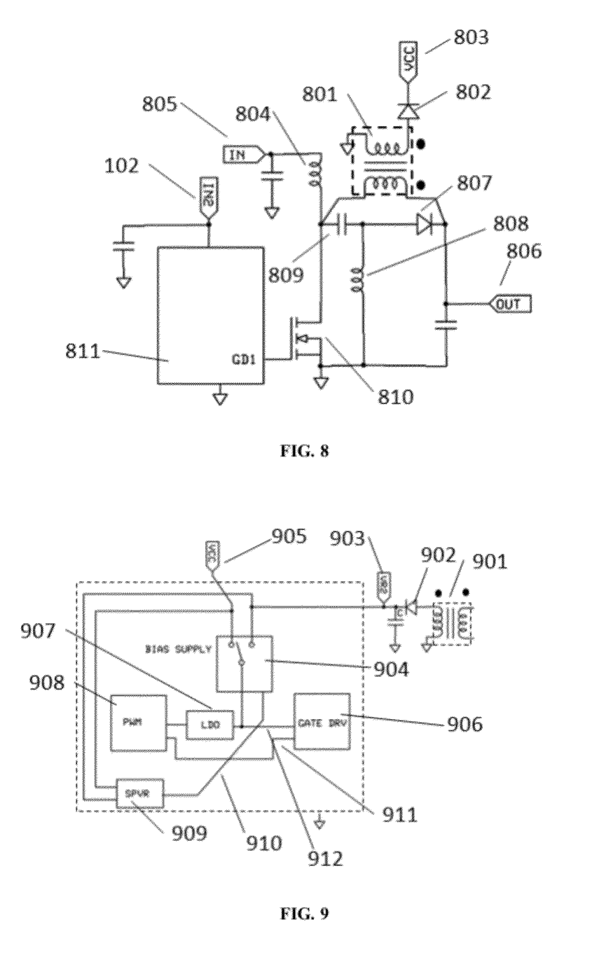

FIG. 8 shows another embodiment of the present invention. It shows a simplified diagram of the power stage of a SEPIC regulator and the components of the present invention. 811 is the PWM or switching controller along with the gate driver. 102 is the input supply to 811, analogous to the input described in FIG. 1. Transformer (801), rectifier (802) and rectifier output (803) are components of the present invention. Smoothing capacitors connected between 803 and the ground terminal are not shown for simplicity. 803 is connected to the output of the linear regulator inside 811, similar to the previous embodiments of this invention shown. 804 is the input inductor of the SEPIC. 805 and 806 are the input and outputs of the power stage of this converter. 807 is the power rectifier and 808 is the output side inductor. The primary winding of the transformer (801) is connected between the switching node (809) and the regulated output (806). 802 rectifies the voltage of the secondary winding of 801. 810 is the power switch.

The embodiment of this invention with a Cuk converter, not shown for brevity, is obviously analogous to that of the SEPIC disclosed here. Similar to circuit operation of the present invention described previously for the buck and boost regulators, the switching action of 810 results in a regulated voltage at 803.

FIG. 9 shows one embodiment of the complete bias supply and supervisory control circuit for the PWM or switching controller and gate driver. It shows the PWM or switching controller (908) and the gate driver (906), bias supply switch (904), Low Drop Out Regulator (LDO, 907) and supervisor circuit (909). Instead of being a PWM switching controller, 908 may also be a variable frequency, variable-on or variable-off time switch mode controller. These circuit blocks form a part of the DC/DC converter. The blocks shown may be integrated in a single semiconductor die or they may be constructed using discrete components. Alternately, they may be constructed using partially integrated and partially discrete components. 905 is connected to the input supply voltage of the DC conversion system. At initial power up, power is provided from the input supply voltage of the DC conversion system to all the blocks of the bias supply of FIG. 9 via 905. 901, 902 and 903 along with one or more filter capacitors connected to 903 constitute the DC bias supply described earlier in FIG. 3, FIG. 4A, FIG. 4B, FIG. 5, FIG. 7A, FIG. 7B, and FIG. 8. 904 is a Single Pole Double Throw (SPDT) switch controlled by 909 via the connection labeled 910. 911 and 912 are electrical connections between 908 and 906, and also 907 and 906 respectively.

Circuit Operation:

At initial power up, power is supplied to the Gate Driver (906), or switching controller (908) and Supervisor (909) circuit blocks from the input voltage of the DC/DC power conversion system via 905. The supervisor (909) sets the SPDT switch (904) via one or more control lines (910) to the input power available at 905. The input power is directly fed to 906, which drives one or more external or integrated switching MOSFETs of the DC/DC converter. 912 shows the electrical node connecting the switch (904) to both 906 and the LDO (907). 907 is a linear regulator that regulates the input voltage to a lower voltage to power the PWM or switching controller (908), supervisor circuit (909), and in some embodiments also the gate driver (906). With power available to all the blocks of the DC/DC power converter, the converter starts up and the voltage at its output begins to rise to the desired value. Simultaneously, 901 and 902 along with filter capacitors connected to 903 develop a proportional voltage determined by the turns ratio between the primary and secondary windings of 901, and the desired regulated output voltage of the dc converter. The supervisor circuit (909) monitors both the voltage developed at 903 and the input voltage of the Power converter available at 905. When the voltage at 903 crosses one of an arbitrary number of threshold voltages, or when it reaches one of an arbitrary number of a pre-determined range of voltages, 909 toggles the switch (904) to provide power to 906, 907, 908 and 909 (via 907) from the voltage developed at 903. At this point, no power is drawn from the input power to the DC converter via 905 to power 906, 907, 908 and 909.

Since the voltage developed at 903 is lower than the input voltage at 905 to the DC/DC converter, power dissipation in the LDO (907) is reduced. Power consumption in the gate drive circuits of the switching MOSFETs is also reduced because of the reduced gate drive signal amplitude from 906. The supervisor (909) monitors both the input voltage at 905 and the developed voltage at 903. As long as a stable voltage is developed at 903, and this voltage remains within a specified range, 909 continues to maintain the position of the switch (904) connected to 903. The supervisor (909) switches the position of 904 back to 905 when the voltage at 903 is detected to be outside the specified range. The functional blocks represented by 904, 906, 908 and 909 are implemented using wholly analog, wholly digital or by using a combination of analog and digital circuit techniques. 907 is implemented by using either wholly analog or by using a combination of analog and digital circuit techniques. Sensing and control lines used in this invention are implemented using wholly analog, wholly digital or by using a combination of analog and digital circuit techniques. The embodiment of FIG. 9 ensures that the power flow is maintained such that it always achieves smooth operation and optimum efficiency of the power conversion system. Other possible variations of this embodiment have an arbitrary number of secondary windings developing various bias supplies to power the different blocks of FIG. 9. In yet other possible variations of this embodiment an arbitrary number of transformers are employed to develop the various bias supplies to power the different blocks of FIG. 9.

What is claimed is:

1. An efficient bias power supply for non-isolated DC/DC power conversion applications, without using an extra switching controller and power switches and employing a transformer in forward conversion mode. One end of the primary winding of this transformer is connected to the input or output power terminal and its other end is connected to the switching node of the power switch that is referenced to the ground terminal.

2. The efficient bias power supply of claim 1 employs a transformer in forward conversion mode with an arbitrary number of secondary windings to power different blocks of a power conversion system. Such arbitrary number of additional windings can be employed to power various blocks of the non-isolated DC/DC power conversion system of claim 1. Furthermore an arbitrary number of such additional windings can be used to supply bias power to an arbitrary number of other isolated or non-isolated power conversion systems.

3. The efficient bias power supply of claim 1 employs an arbitrary number of transformers in forward conversion mode, each with an arbitrary number of secondary windings to power different blocks of the power conversion system. Such arbitrary number of additional transformers and windings can be employed to power various blocks of the non-isolated DC/DC power conversion system of claim 1. Furthermore an arbitrary number of such additional transformers and windings can be used to supply bias power to an arbitrary number of other isolated or non-isolated power conversion systems.

4. The efficient bias supply of claim 1 is employed and constructed in conjunction with various power conversion topologies such as, but not limited to synchronous buck, boost, SEPIC, and Cuk converters to realize various power conversion systems such as, but not limited to POL converters, battery chargers, LED drivers, solar converters.

5. The combination of the methods of claim 1 and the entire control circuit described with reference to FIG. 9 are employed to develop an efficient bias power supply that maintains smooth operation of a main non-isolated DC/DC power conversion system. Furthermore additional bias supplies developed by using the methods of claims 2 and 3 are used to provide bias power to other non-isolated and isolated power conversion systems.

6. The efficient bias power supply of claim 1 and the entire control circuit described with reference to FIG. 9 is entirely or partially integrated on a silicon die or it may be realized using separate die and/or discrete components.
